(19) United States
(12) Patent Application Publication
(10) Pub. No.: US 2026/0329207 A1
(43) Pub. Date: Oct. 22, 2026

(54) FIXING DEVICE AND IMAGE FORMING APPARATUS

(71) Applicant: KYOCERA Document Solutions Inc., Osaka (JP)

(72) Inventors: Yuhiro SAKAI, Osaka (JP); Tomoyasu YAMADA, Osaka (JP)

(73) Assignee: KYOCERA Document Solutions Inc., Osaka (JP)

(21) Appl. No.: 19/651,240

(22) Filed: Apr. 17, 2026

(30) Foreign Application Priority Data
Apr. 22, 2025 (JP) 2025-070474

(51) Int. Cl. G03G 15/20

(52) U.S. Cl. CPC G03G 15/2053; G03G 15/2064; G03G 2215/004

(57) ABSTRACT

A fixing device includes a fixing belt, a pair of belt holding members, a pressure member, a pressure adjusting part, a medium separation part, and a medium guide part. The pair of belt holding members are inserted into both ends of the fixing belt. The pressure member forms a pressurizing region between the fixing belt and the pressure member. The pressure adjusting part moves the fixing belt between a pressure increased position and a pressure decreased position. The medium separation part includes a separation guide which separates the medium from the fixing belt. The medium guide part includes a conveying guide which guides the medium separated from the fixing belt. The separation guide is pressed against the pair of belt holding members and moves integrally with the fixing belt. The conveying guide moves in a pressure decreasing direction in which a contact pressure applied from the medium is decreased.

### INCORPORATION BY REFERENCE

This application is based on and claims the benefit of priority from Japanese patent application No. 2025-070474 filed on Apr. 22, 2025 which is incorporated by reference in its entirety.

### BACKGROUND

The present disclosure relates to a fixing device which fixes a toner image on a medium and an image forming apparatus.

An electrophotographic image forming apparatus includes a fixing device for fixing a toner image on a paper. The fixing device includes a fixing belt in contact with a pressure roller, a pressurizing mechanism forming a nip between the fixing belt and the pressure roller, a pressure release mechanism for releasing the pressure applied by the pressurizing mechanism, a separation guide preventing the paper from wrapping around the fixing belt, and a paper guide part disposed on the downstream side of the separation guide in the paper conveying direction. The separation guide moves together with the fixing belt in response to the pressure change in the nip. Because the separation guide is directly positioned to a flange member that regulates the rotational path of the fixing belt, even with the configuration where the separation guide moves together with the fixing belt, a constant gap is maintained between the leading edge of the separation guide and the surface layer of the fixing belt.

### SUMMARY

A fixing device according to the present disclosure includes a fixing belt, a pair of belt holding members, a pressure member, a pressure adjusting part, a medium separation part, and a medium guide part. The fixing belt has flexibility, is formed in a cylindrical shape extending in an axial direction, and heats toner on a medium while rotating around an axis. The pair of belt holding members are inserted into both ends of the fixing belt in the axial direction and hold the fixing belt in the cylindrical shape. The pressure member forms a pressurizing region between the fixing belt and the pressure member, and pressurizes the toner on the medium passing through the pressurizing region while rotating around an axis. The pressure adjusting part is connected to the fixing belt via the pair of the belt holding members, and moves the fixing belt between a pressure increased position at which the pressurizing region is increased in pressure and a pressure decreased position at which the pressurizing region is decreased in pressure. The medium separation part includes a separation guide which separates the medium after the medium passes through the pressurizing region, from the fixing belt. The medium guide part includes a conveying guide which guides the medium separated from the fixing belt by the separation guide and conveyed. The separation guide is pressed against the pair of belt holding members and moves integrally with the fixing belt. The conveying guide moves in a pressure decreasing direction in which a contact pressure applied from the medium when the conveying guide is pressed by the conveyed is decreased.

An image forming apparatus includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to the embodiment of the present disclosure.

FIG. 3 is a plan view showing the fixing device according to the embodiment of the present disclosure.

FIG. 4 is a cross-sectional view showing the fixing device according to the embodiment of the present disclosure, in which a pressurizing region is increased in pressure.

FIG. 5 is a side view showing the fixing device according to the embodiment of the present disclosure, in which the pressurizing region is increased in pressure.

FIG. 6 is a cross-sectional view showing the fixing device according to the embodiment of the present disclosure, in which the pressurizing region is decreased in pressure.

FIG. 7 is a side view showing the fixing device according to the embodiment of the present disclosure, in which the pressurizing region is decreased in pressure.

FIG. 8 is a perspective view showing a medium separation part and a medium guide part of the fixing device according to the embodiment of the present disclosure.

FIG. 9 is a perspective view showing the medium separation part of the fixing device according to the embodiment of the present disclosure.

FIG. 10 is a perspective view showing the medium guide part of the fixing device according to the embodiment of the present disclosure.

FIG. 11 is a cross-sectional view showing the medium guide part of the fixing device according to an embodiment of the present disclosure.

FIG. 12 is a cross-sectional view explaining the operation of the medium guide part of the fixing device according to the embodiment of the present disclosure.

### DETAILED DESCRIPTION

Hereinafter, with reference to the attached drawings, an embodiment of the present disclosure will be described. Fr, Rr, L, R, U, and D in the drawings indicate the front, rear, left, right, upper, and down. The front-and-rear direction, the left-and-right direction (the axial direction) and the upper-and-down direction are orthogonal to each other. Although the terms showing direction and position are used in the specification, they are used for convenience of description and are not intended to limit the scope of the disclosure. In the drawings, the shapes, dimensions, angles, positions, and the like of the constituent members are not necessarily accurate and are schematized for the purpose of explanation.

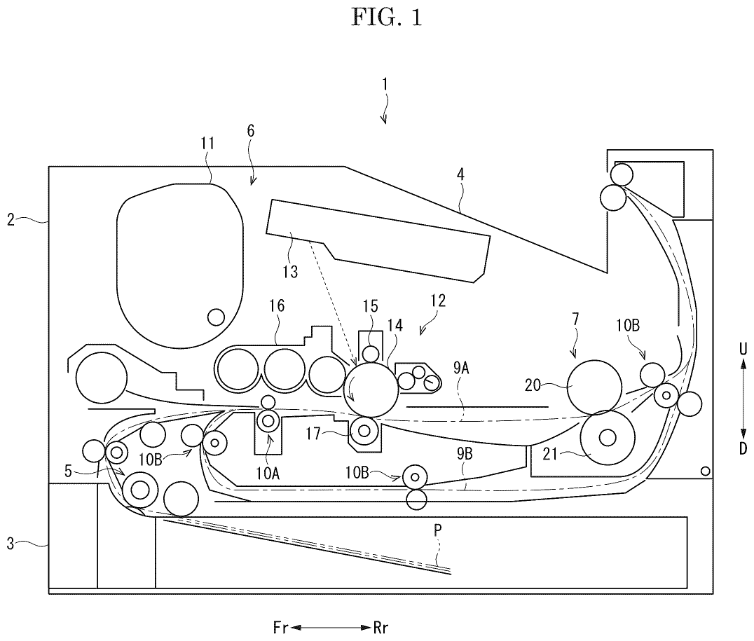

With reference to FIG. 1, an image forming apparatus 1 according to the embodiment will be described. FIG. 1 is a schematic view (side view) showing the image forming apparatus 1.

The image forming apparatus 1 is an electrophotographic type printer. The image forming apparatus 1 includes an apparatus main body 2 having a substantially rectangular parallelepiped appearance. In the lower portion in the apparatus main body 2, a paper feeding cassette 3 which stores a paper P is detachably provided. On the upper surface of the apparatus main body 2, a discharge tray 4 is provided. The apparatus main body 2 includes a metal frame and a synthetic resin member fixed to the frame. The paper P as an example of the medium is not limited to a paper sheet, but may be a resin sheet or the like. In this specification, the terms “upstream”, “downstream” and similar terms refer to the “upstream”, “downstream” and similar concepts in a conveying direction of the paper P.

The image forming apparatus 1 includes a paper feeding device 5, an image forming device 6, and a fixing device 7. The paper feeding device 5 is provided at the upstream end of a conveying path 9A extending from the paper feeding cassette 3 to the discharge tray 4, and feeds the paper P stored in the paper feeding cassette 3 one by one to the conveying path 9A. The image forming device 6 is provided in the middle portion of the conveying path 9A, and forms a toner image on the conveyed paper P. The fixing device 7 is provided on the downstream portion of the conveying path 9A, and thermally fixes the toner image on the paper P.

A pair of registration rollers 10A is provided on the conveying path 9A to temporarily block the conveyed paper P and to correct its skew. Below the conveying path 9A, an inversion conveying path 9B is provided, which branches from the downstream side portion of the conveying path 9A and merges with the upstream side portion of the conveying path 9A. On the inversion conveying path 9B, a plurality of pairs of conveying rollers 10B for conveying the paper P are provided. The pair of conveying rollers 10B is also provided on the conveying path 9A downstream of the fixing device 7.

The image forming device 6 includes a toner container 11, a drum unit 12, and an optical scanning device 13. The toner container 11 is disposed in the front upper portion in the apparatus main body 2, and contains, for example, black toner (developer). The drum unit 12 includes a photosensitive drum 14, a charging device 15, a developing device 16, and a transfer roller 17. The photosensitive drum 14 is formed into a substantially cylindrical shape, and is driven by a motor (not shown) to rotate around an axis. The charging device 15, the developing device 16, and the transfer roller 17 are arranged around the photosensitive drum 14 in the order of the image forming process. The transfer roller 17 comes into contact with the photosensitive drum 14 from below, and forms a transfer nip. The optical scanning device 13 is disposed above the photosensitive drum 14, and emits scanning light toward the surface of the photosensitive drum 14.

[Image Forming Process] A control part (not shown) that centrally controls the image forming apparatus 1 executes the image forming process as follows, based on image data input from an external terminal.

The charging device 15 charges the surface of the photosensitive drum 14. The optical scanning device 13 emits scanning light based on the image data, and forms an electrostatic latent image on the photosensitive drum 14. The developing device 16 develops the electrostatic latent image on the photosensitive drum 14 into a toner image using the toner supplied from the toner container 11. The paper feeding device 5 feeds the paper P from the paper feeding cassette 3 one by one to the conveying path 9A. The paper P is conveyed along the conveying path 9A, after the skew of the paper is corrected by the pair of registration rollers 10A, and enters the transfer nip. The transfer roller 17 transfers the toner image from the photosensitive drum 14 to the surface of the paper P as it passes through the transfer nip. The fixing device 7 thermally fixes the toner image to the paper P. In the case of single-sided printing, the paper P that passes through the fixing device 7 is discharged to the discharge tray 4.

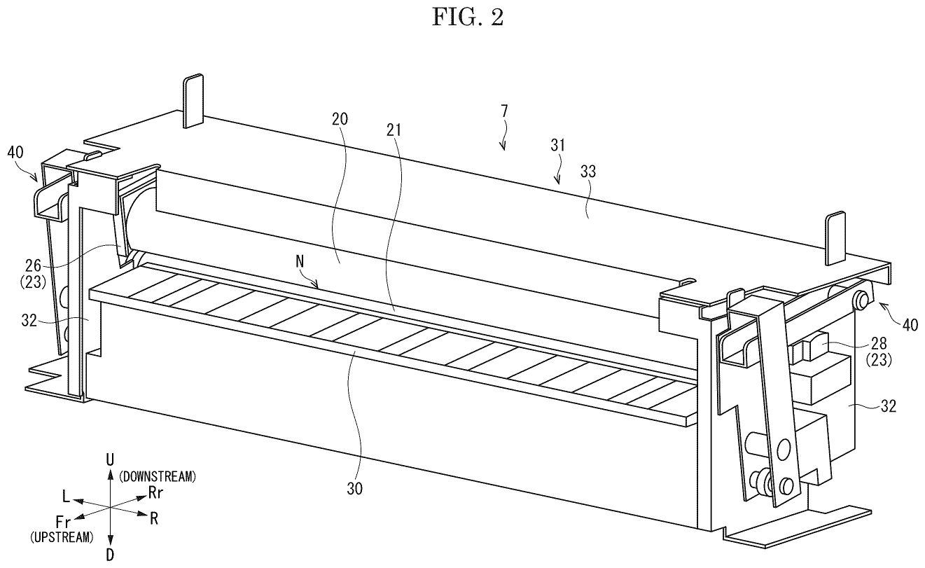

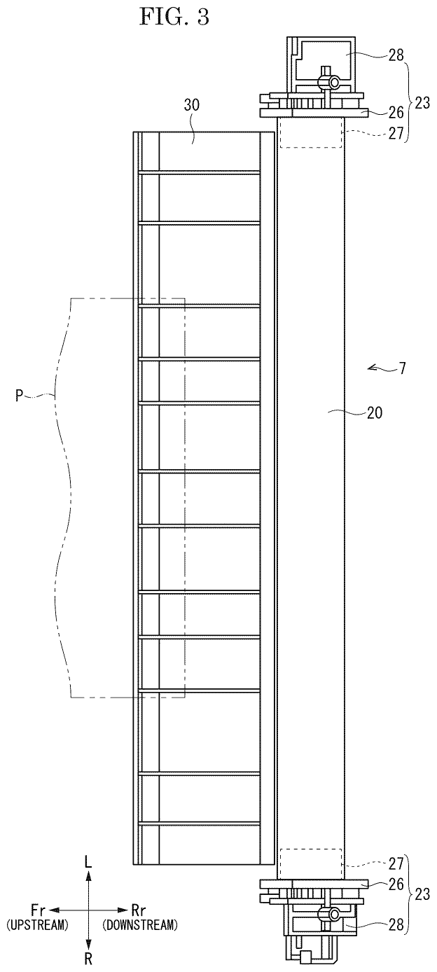

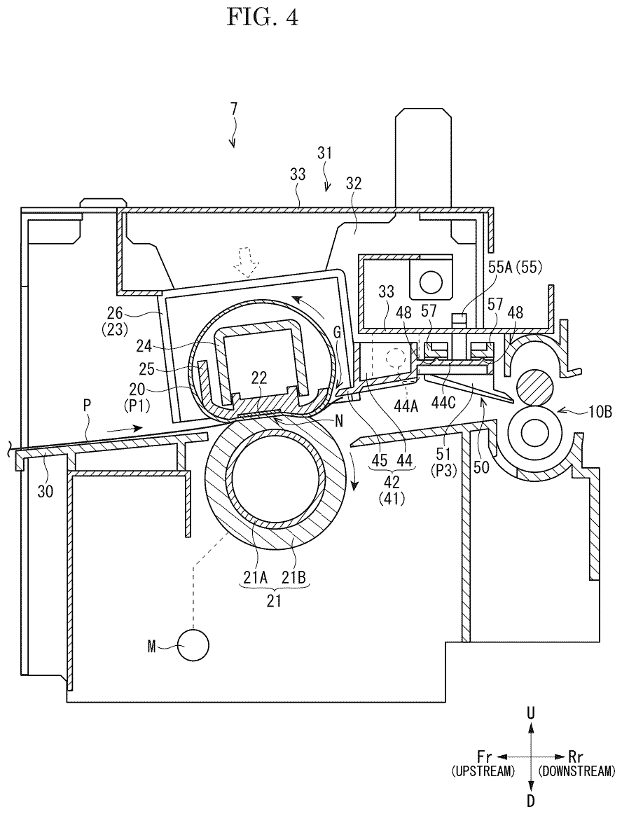

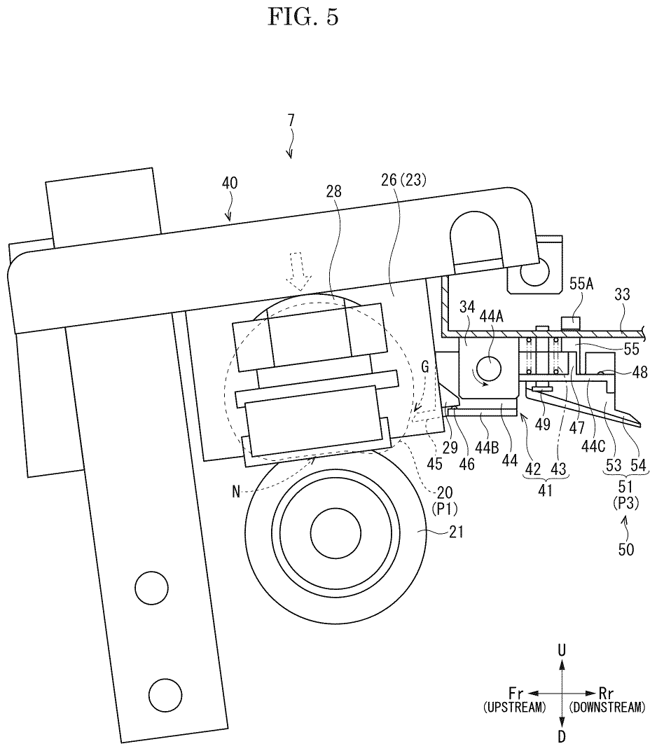

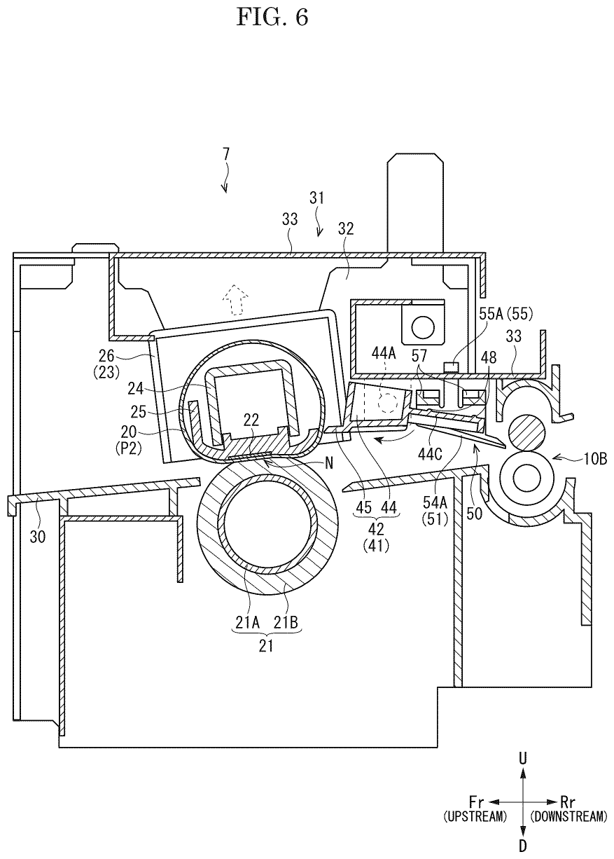

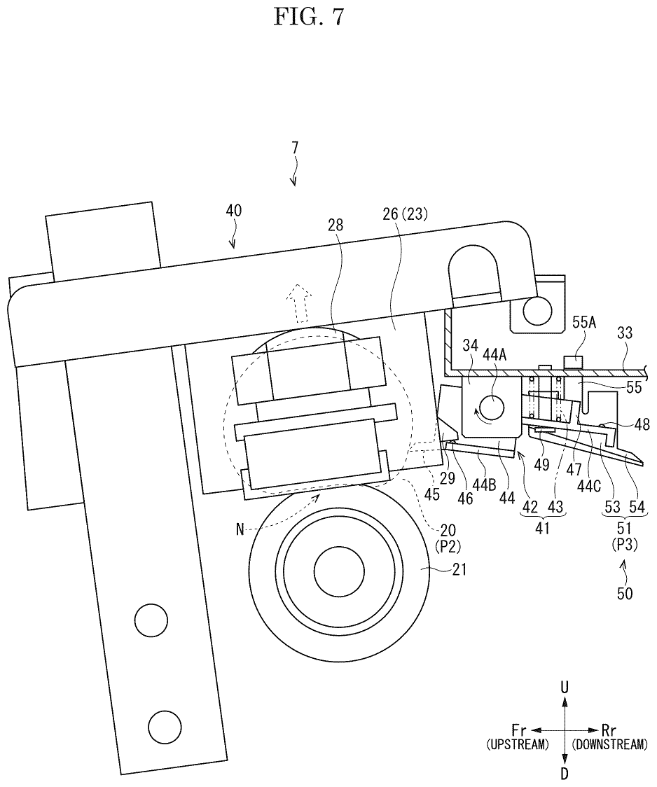

In the case of double-sided printing, the paper P that passes through the fixing device 7 switches back at the downstream end of the conveying path 9A and is sent to the inversion conveying path 9B. The paper P is conveyed by the pairs of conveying rollers 10B, returned from the inversion conveying path 9B to the conveying path 9A, after the skew is corrected by the pair of registration rollers 10A, and is then sent to the transfer nip. Subsequently, the toner image is transferred to the paper P, thermally fixed, and the double-sided printed paper P is discharged to the discharge tray 4.

[Fixing Device] Next, with reference to FIG. 2 to FIG. 7, the fixing device 7 will be described. FIG. 2 is a perspective view showing the fixing device 7. FIG. 3 is a plan view showing the fixing device 7. FIG. 4 is a cross-sectional view showing the fixing device 7 in which the pressurizing region N is increased in pressure. FIG. 5 is a side view showing the fixing device 7 in which the pressurizing region N is increased in pressure. FIG. 6 is a cross-sectional view showing the fixing device 7 in which the pressurizing region N is decreased in pressure. FIG. 7 is a side view showing the fixing device 7 in which the pressurizing region N is decreased in pressure.

As shown in FIG. 2 to FIG. 4, the fixing device 7 includes a fixing belt 20, a pressure roller 21, a heater 22, a pair of pressure adjustment parts 40, a medium separation part 41, and a medium guide part 50. The fixing belt 20, the pressure roller 21, and other components are supported by a fixing frame 31. As shown in FIG. 2, the fixing frame 31 includes a pair of side plate frames 32 erected via an interval in the left-and-right direction and a plurality of crossing frames 33 (see also FIG. 4) providing between the pair of side plate frames 32. The side plate frames 32 and the crossing frames 33 are made, for example, of metallic materials such as iron or stainless steel.

<Fixing Belt> As shown in FIG. 2 to FIG. 4, the fixing belt 20 (heating member) is an endless belt formed into a substantially cylindrical shape extending in the left-and-right direction (the axial direction). The fixing belt 20 is made of material having heat resistance and flexibility (polymer resin or metal, or combination of polymer resin and metal). A pair of belt holding members 23 are inserted into both ends of the fixing belt 20 in the left-and-right direction (see FIG. 3). Each belt holding member 23 is attached to the side plate frame 32, and the fixing belt 20 is supported by the side plate frames 32 via the pair of belt holding members 23. Since the pair of belt holding members 23 has substantially a left-and-right symmetrical structure, this specification primarily describes one belt holding member 23.

(Belt Holding Member) As shown in FIG. 3, the belt holding member 23 includes a partition part 26, an insertion part 27, and an adjustment pressure-receiving part 28. The partition part 26, the insertion part 27, and the adjustment pressure-receiving part 28 are made of synthetic resin having heat resistance and wear resistance, and integrally formed.

The partition part 26 is formed into a substantially flat plate that covers the end surface of the fixing belt 20 in the left-and-right direction (the axial direction). The insertion part 27 is formed into a substantially cylindrical shape and projects toward the interior of the fixing belt 20 from the inner surface of the partition part 26. The outer peripheral surface of the insertion part 27 comes into contact with the inner peripheral surface of the fixing belt 20, and the insertion part 27 supports the fixing belt 20 rotatably around the axis while holding the fixing belt 20 in a cylindrical shape. The adjustment pressure-receiving part 28 is formed into a block shape with a dome-shaped curved upper surface (see FIG. 2 and FIG. 5) and projects from the outer surface of the partition part 26 in the opposite direction to the insertion part 27. The adjustment pressure-receiving part 28 is supported by the side plate frame 32. Lubricant, such as grease, is interposed between the outer peripheral surface of the insertion part 27 and the inner peripheral surface of the fixing belt 20.

As shown in FIG. 4, in the space enclosed by the fixing belt 20, a crossing member 24 and a pressure-receiving member 25 are provided. The crossing member 24 is made of metal material such as stainless steel, formed into a substantially U-shaped groove with the lower surface open, extends in the left-and-right direction, and is supported between the belt holding members 23 (the partition parts 26). The pressure-receiving member 25 is fixed to the lower portion of the crossing member 24. The pressure-receiving member 25 is made of, for example, synthetic resin having heat resistance and wear resistance, formed into a substantially U-shaped groove with the upper surface open, and extends in the left-and-right direction. The pressure-receiving member 25 curves along the inner surface of the fixing belt 20 and comes into contact with the lower side portion (the pressurizing region N side portion) of the inner surface of the fixing belt 20. Lubricant, such as grease, is interposed between the lower surface of the pressure-receiving member 25 and the inner peripheral surface of the fixing belt 20.

<Pressure Roller> The pressure roller 21 as one example of the pressure member is formed into a substantially cylindrical shape extending in the left-and-right direction. As shown in FIG. 4, the pressure roller 21 has a metal core 21A and an elastic layer 21B, such as a silicone sponge, laminated around the outer peripheral surface of the metal core 21A. The pressure roller 21 (core 21A) is supported by the side plate frames 32 rotatably around an axis. The pressure roller 21 (core 21A) is connected to a drive motor M via a fixing drive transmission part, such as a gear train. The pressure roller 21 is driven by receiving a driving force (rotational force) from the drive motor M, and rotates around the axis. The pressure roller 21 comes into contact with the fixing belt 20 from below, and forms a pressurizing region N between the pressure roller 21 and the fixing belt 20. As the paper P passes through the pressurizing region N, the toner image is fixed to the paper P. The pressurizing region N refers to the region extending from the upstream position where the pressure is 0 Pa, through the position where pressure is applied, to the downstream position where the pressure again becomes 0 Pa.

(Entry Guide Member) As shown in FIG. 2 to FIG. 4, on the upstream side of the pressurizing region N, an entry guide member 30 is provided to guide the paper P toward the pressurizing region N. The entry guide member 30 is formed in a substantially flat plate shape and is supported by the side plate frames 32. The entry guide member 30 is provided in an inclined posture slightly upward from the upstream to the downstream (the pressurizing region N). The paper P is conveyed such that its center in the left-and-right direction aligns approximately with the center of the entry guide member 30 in the left-and-right direction. Furthermore, the dimension (width) of the entry guide member 30 in the left-and-right direction is set to be wider than the dimension (width) of the largest size paper P in the left-and-right direction.

<Heater> As shown in FIG. 4, the heater 22 is fixed to the lower surface of the pressure-receiving member 25. The heater 22 has a substrate made of insulator such as ceramic and a plurality of heating resistors formed on the substrate. The heater 22 is in contact with the inner surface of the fixing belt 20 facing the pressurizing region N, generates heat when supplied with power, and heats the fixing belt 20. The heater 22 is not limited to a plate shape; it may also be, for example, a halogen heater placed within the space enclosed by the fixing belt 20 (not shown).

<Pressure Adjustment Part> As shown in FIG. 2, the pressure adjustment parts 40 are provided on the outer surfaces of the side plate frames 32. The pair of pressure adjustment parts 40 are (indirectly) connected to the fixing belt 20 via the pair of belt holding members 23. As a specific example, each pressure adjustment part 40 is biased by a pressure adjustment spring (not shown) and pressed against the upper portion of the adjustment pressure-receiving part 28 of the belt holding member 23. As a result, the fixing belt 20 is pressed against the pressure roller 21 and disposed (moves) to a pressure increased position P1 where the pressurizing region N is increased in pressure (see FIG. 4 and FIG. 5). Furthermore, the pair of pressure adjustment parts 40 are connected to a pressure adjustment motor (not shown) via a power transmission mechanism such as a gear train (not shown). Each pressure adjustment part 40 receives a driving force from the pressure adjustment motor and releases the pressing against the upper portion of the adjustment pressure-receiving part 28, against the biasing force of the pressure adjustment spring. As a result, the fixing belt 20 releases the pressing against the pressure roller 21 and disposed (moves) to a pressure decreased position P2 where the pressurizing region N is decreased in pressure (see FIG. 6 and FIG. 7). As described above, each pressure adjustment part 40 has the function of moving the fixing belt 20 between the pressure increased position P1 and the pressure decreased position P2, thereby changing the pressure in the pressurizing region N.

<Medium Separation Part> As shown in FIG. 4 and FIG. 5, the medium separation part 41 is provided on the downstream side of the pressurizing region N. The medium separation part 41 includes a separation guide 42 extending in the left-and-right direction (axial direction). The separation guide 42 is supported by the crossing frame 33 of the fixing frame 31. The separation guide 42 has a separation claw portion 45 facing the surface of the fixing belt 20 on the downstream side of the pressurizing region N. A slight gap G is formed between the tip of the separation claw portion 45 and the surface of the fixing belt 20. That is, the tip of the separation claw portion 45 is not in contact with the surface of the fixing belt 20.

<Medium Guide Part> As shown in FIG. 4 and FIG. 5, the medium guide part 50 is provided on the downstream side of the medium separation part 41. The medium separation part 41 and the medium guide part 50 are arranged along the conveying direction of the paper P. The paper P, after passing through the pressurizing region N, is conveyed downstream while being guided by the medium separation part 41 and the medium guide part 50.

[Fixing Process] Here, the operation of the fixing device 7 (fixing process) will be described. The control part of the image forming apparatus 1 executes the fixing process as a part of the image forming process as follows.

When the image forming process (fixing process) is executed normally, the pressure adjustment parts 40 strongly press the belt holding members 23 (adjustment pressure-receiving parts 28) downward to dispose the fixing belt 20 at the pressure increased position P1. The fixing belt 20 is pressed against the pressure roller 21, so that the pressurizing region N is increased in pressure.

The drive motor M rotates the pressure roller 21 around the axis, and the fixing belt 20 rotates following the rotation of the pressure roller 21 (see the arrow in FIG. 4). The heater 22 heats the fixing belt 20 (the pressurizing region N). When the fixing belt 20 (heater 22) is heated to a predetermined temperature, the control part initiates the previously described image forming process. The paper P, to which the toner image is transferred, is conveyed along the entry guide member 30 and enters the pressurizing region N. The fixing belt 20 heats the toner (the toner image) on the paper P passing through the pressurizing region N while rotating around the axis. The pressure roller 21 applies pressure to the toner on the paper P passing through the pressurizing region N while rotating around the axis. Then, the toner image is fixed to the paper P, and a fixed image is formed on the paper P.

Since the toner on the paper P melts due to heating while passing through the pressurizing region N, the paper P tends to easily adhere to the surface of the fixing belt 20 via the molten toner. However, the leading edge of the paper P passed through the pressurizing region N abuts on the separation claw portion 45 of the separation guide 42 and is peeled away from the surface of the fixing belt 20. In this manner, the separation guide 42 separates the paper P passed through the pressurizing region N from the fixing belt 20. A conveying guide 51 guides the paper P separated from the fixing belt 20 and being conveyed. The paper P with the fixed image is then discharged to the discharge tray 4.

[Jam Treatment] A conveying failure of the paper P, referred to as a paper jam, may occur between the fixing belt 20 and the pressure roller 21 (the pressurizing region N). When the jam occurs, a jam treatment is performed to remove the paper P jammed in the pressurizing region N.

For example, if a sensor (not shown) installed in the conveying path 9A near the fixing device 7 cannot detect the conveying of the paper P, the control part determines that “a jam occurs” based on the signal transmitted from the sensor (or the absence of the signal transmission). Each pressure adjustment part 40 receives the driving force from the pressure adjustment motor, and moves the fixing belt 20 from the pressure increased position P1 (see FIG. 4 and FIG. 5) to the pressure decreased position P2 (see FIG. 6 and FIG. 7). In this state, since the pressurizing region N is decreased in pressure, it becomes possible to pull out the paper P jammed in the pressurizing region N. The operator opens a cover (not shown) of the apparatus main body 2, and grasps and pulls out the paper P jammed in the pressurizing region N. In the fixing device 7 of this embodiment, in the state where the pressurizing region N is decreased in pressure, the fixing belt 20 is not completely separated from the pressure roller 21 but in slight contact with the pressure roller 21 with a minor pressure; however, the present disclosure is not limited to this configuration. For example, the fixing belt 20 may be completely separated from the pressure roller 21.

After the paper P is pulled out, when the operator closes the cover, a signal is sent from a sensor (not shown) that detects the opening and closing of the cover to the control part. Each pressure adjustment part 40 returns by receiving the driving force of the pressure adjustment motor, and the fixing belt 20 is biased by each pressure adjustment spring to be moved from the pressure decreased position P2 (see FIG. 6 and FIG. 7) to the pressure increased position P1 (see FIG. 4 and FIG. 5). As a result, the fixing belt 20 is pressed against the pressure roller 21, so that the pressurizing region N is increased in pressure.

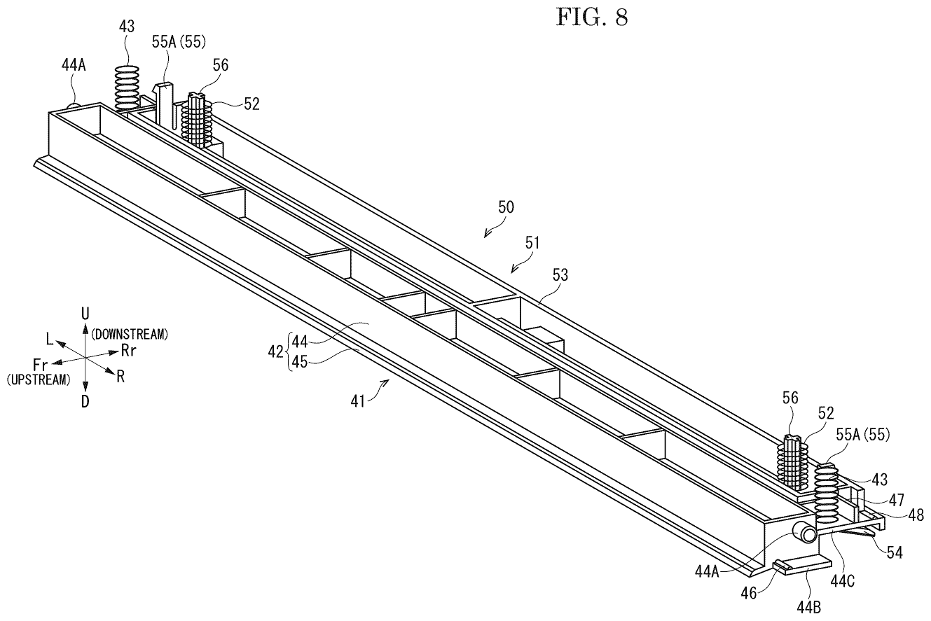

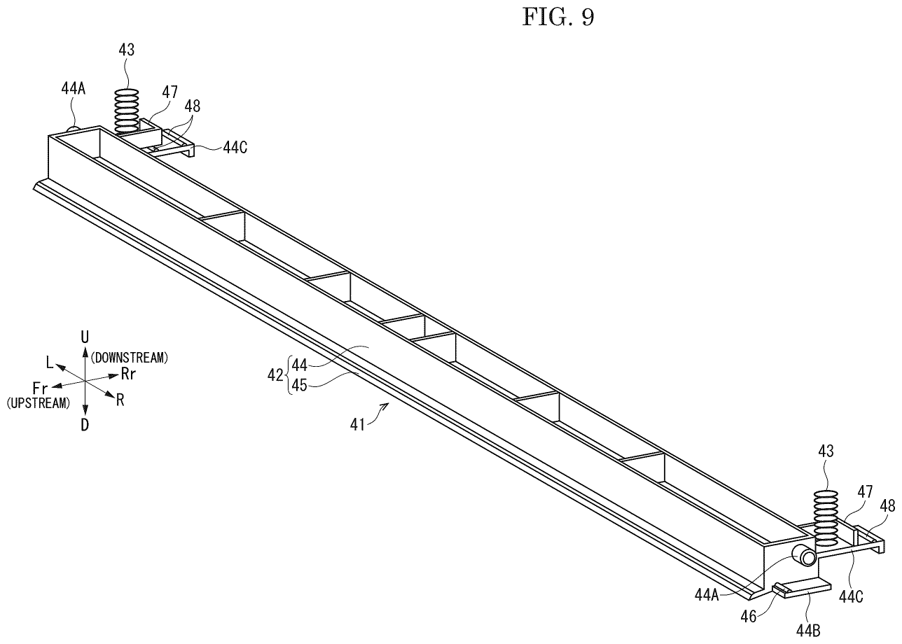

Incidentally, the paper P adhering to the surface of the fixing belt 20 may wrap around the fixing belt 20 and cause the jam. To prevent the paper P from wrapping around the fixing belt 20, the separation guide 42 of the medium separation part 41 separates the paper P adhering to the surface of the fixing belt 20 (see FIG. 4). For the separation guide 42 to effectively exhibit the function of separating the paper P from the surface of the fixing belt 20, it is required that the separation guide 42 be accurately positioned at the desired position and that the gap G (see FIG. 4 and FIG. 5) between the tip of the separation claw portion 45 and the surface of the fixing belt 20 be maintained at the desired value. Therefore, the fixing device 7 according to this embodiment includes a structure (medium separation part 41) for accurately positioning the separation guide 42.

[Details of the Medium Separation Part] With reference to FIG. 4 to FIG. 9, details of the medium separation part 41 will be described. FIG. 8 is a perspective view showing the medium separation part 41 and the medium guide part 50. FIG. 9 is a perspective view showing the medium separation part 41.

As shown in FIG. 8 and FIG. 9, the medium separation part 41 includes the separation guide 42 and a pair of separation biasing members 43.

<Separation Guide> The separation guide 42 has a separation body part 44 formed into a substantially box-shape elongated in the left-and-right direction, and a separation claw portion 45 formed into a substantially plate-shape elongated in the left-and-right direction. The separation claw portion 45 projects forward (toward the upstream side) from the lower end portion of the front surface of the separation body part 44. The separation claw portion 45 is provided in a posture inclined downward and forward (toward the pressurizing region N) (see FIG. 4).

(Separation Main Body Part) The separation body part 44 is turnably supported by the crossing frame 33 via a pair of separation turning shafts 44A projecting outward from both left and right side surfaces. Specifically, as shown in FIG. 5, a pair of turning support pieces 34 are provided extending downward from the left and right end portions of the crossing frame 33, and the separation turning shafts 44A are rotatably fitted to the turning support pieces 34. The separation guide 42 is disposed below the crossing frame 33 and is provided to be turned around the separation turning shafts 44A.

As shown in FIG. 8 and FIG. 9, a pair of pressing plates 44B are provided on the left and right side surfaces of the separation body part 44. The pair of pressing plates 44B extend outward from the lower portions of the left and right side surfaces of the separation body part 44. Each pressing plate 44B is a flat plate having a substantially rectangular shape when viewed in a plan and is provided below the separation turning shaft 44A. A substantially semicylindrical upstream rib 46 elongated in the left-and-right direction is provided on the upper surface of each pressing plate 44B. Each upstream rib 46 projects upward from the front end portion (upstream end portion) of the upper surface of the pressing plate 44B. Each upstream rib 46 is provided on the front side of (on the upstream side of) the separation turning shaft 44A and interferes with the partition part 26 of the belt holding member 23. Specifically, as shown in FIG. 5 and FIG. 7, a pressing projection 29 projects rearward from the lower portion of the rear end surface (downstream end surface) of the partition part 26, and each upstream rib 46 comes into contact with the lower surface of the pressing projection 29. Thus, the separation guide 42 comes into contact with the pair of belt holding members 23 from the front side (upstream side) of and below the separation turning shaft 44A (on the side of the pressurizing region N) via the pair of upstream ribs 46.

As shown in FIG. 8 and FIG. 9, a pair of pressure-receiving plates 44C are provided on the rear surface of the separation body part 44. The pair of pressure-receiving plates 44C extend rearward from the left and right end portions of the rear surface of the separation body part 44. Each pressure-receiving plate 44C is a flat plate having a substantially rectangular shape when viewed in a plan. A partition rib 47 and a downstream rib 48 are erected on the upper surface of each pressure-receiving plate 44C. Each partition rib 47 is formed in a substantially L-shape with the outer side open in the left-and-right direction when viewed in a plan, and partitions a space between itself and the rear surface of the separation body part 44 for disposing the separation biasing member 43. A clearance insertion hole (not shown) is formed within the area partitioned by the partition rib 47 of each pressure-receiving plate 44C, and a screw shaft portion 49 (see FIG. 5 and FIG. 7) is allowed to be passed through the insertion hole with clearance. The downstream ribs 48 are provided at a position adjacent to the partition rib 47 and on the rear side (downstream side) of the partition rib 47. Like the upstream rib 46, the downstream rib 48 is formed into a substantially semicylindrical shape extending in the left-and-right direction. The downstream ribs 48 are provided parallel to each other on the pressure-receiving plate 44C separated in the front-and-rear direction (conveying direction), and come into contact with a lower surface of a turning restriction part 57 (see FIG. 4) provided on the conveying guide 51 described later.

<Separation Biasing Member> As shown in FIG. 8 and FIG. 9, each separation biasing member 43 is, for example, a compression coil spring disposed within the space enclosed by the rear surface of the separation body part 44 and the partition rib 47. Each separation biasing member 43 is provided to be wound around the screw shaft portion 49 (see FIG. 5) which passes through the pressure-receiving plate 44C from below. A male thread is formed on the upper end portion of each screw shaft portion 49, and a flange is formed on the lower end portion of each screw shaft portion 49. Each screw shaft portion 49 is provided to pass through the pressure-receiving plate 44C from below, mesh the male thread with a female thread formed on the crossing frame 33, and extend downward from the crossing frame 33. Each screw shaft portion 49 is inserted into the axial center of the separation biasing member 43, and the flange of each screw shaft portion 49 interferes with the pressure-receiving plate 44C. As shown in FIG. 5, each separation biasing member 43 is provided between the pressure-receiving plate 44C and the crossing frame 33, and biases the pressure-receiving plate 44C downward. By the separation biasing members 43 biasing the pressure-receiving plate 44C downward, the separation guide 42 is turned around the separation turning shaft 44A so that the upstream rib 46 of each pressing plate 44B is pressed against the lower surface of the pressing projection 29 of the belt holding member 23. That is, the separation biasing members 43 press the separation guide 42 against the pair of belt holding members 23 and keep each upstream rib 46 coming into contact with the lower surface of the pressing projection 29.

[Operation of the Medium Separation Part] With reference to FIG. 4 to FIG. 7, the operation of the medium separation part 41 will be described. The medium separation part 41 operates in conjunction with the pressure adjustment part 40.

For example, when the image forming process (fixing process) is performed normally, the pressure adjustment part 40 presses the belt holding members 23 downward to position the fixing belt 20 at the pressure increased position P1, and increases the pressure of the pressurizing region N (see FIG. 4 and FIG. 5). In this state, the pressing projection 29 of the belt holding member 23 (partition part 26) presses downward the pressing plate 44B (see FIG. 5), and the separation guide 42 is in a substantially horizontal posture (see FIG. 5). Each upstream rib 46 is kept coming into contact with the lower surface of the pressing projection 29 of the belt holding member 23 by the biasing force of each separation biasing member 43.

Next, when the jam treatment is performed, the pressure adjustment part 40 releases the pressing against the belt holding member 23, positions the fixing belt 20 at the pressure decreased position P2 and decreases the pressure of the pressurizing region N (see FIG. 6 and FIG. 7). The separation guide 42 is applied with the biasing forces from the separation biasing members 43, is turned in the clockwise direction in FIG. 7 while bringing each upstream rib 46 into contact with the lower surface of the pressing projection 29. As a result, the separation guide 42 is in a posture inclined upward (in the pressure decreasing direction) from the rear (downstream side) toward the front (upstream side) (see FIG. 6 and FIG. 7).

Upon completion of the jam treatment, the pressure adjustment part 40 presses the belt holding members 23 downward to position the fixing belt 20 at the pressure increased position P1 and increases the pressure of the pressurizing region N (see FIG. 4 and FIG. 5). The separation guide 42 is turned in the counterclockwise direction in FIG. 5 against the biasing forces of the separation biasing members 43, while bringing each upstream rib 46 into contact with the lower surface of the pressing projection 29. Then, the separation guide 42 is in a substantially horizontal posture, and the tip of the separation claw portion 45 faces the surface of the fixing belt 20 across the gap G (see FIG. 4 and FIG. 5).

In the fixing device 7 of the embodiment described above, the separation guide 42 is pressed against the pair of belt holding members 23, and moved integrally with the fixing belt 20. According to the configuration, the separation guide 42 can be precisely positioned relative to the belt holding members 23, which maintain the fixing belt 20 in a cylindrical shape. Then, when the pressurizing region N is increased in pressure, it becomes possible to set the gap G between the tip of the separation claw portion 45 and the surface of the fixing belt 20 to a desired value. As a result, the separation guide 42 properly exhibits its function of separating the paper P from the surface of the fixing belt 20, thereby suppressing the wrapping of the paper P around the fixing belt 20 (jam).

Furthermore, according to the fixing device 7 of this embodiment, the separation biasing members 43 presses the separation guide 42 against the belt holding members 23, so that the separation guide 42 can be positioned while following the movement of the fixing belt 20.

In the fixing device 7 of the embodiment, the separation guide 42 is biased by the separation biasing member 43 to press the upstream rib 46 against the lower surface of the pressing projection 29. However, the present disclosure is not limited to this configuration. For example, the separation guide 42 may be biased by the separation biasing member 43 to press the upstream rib 46 against the upper surface of the pressing projection 29 (not shown). Alternatively, the separation biasing member 43 may be omitted, and the upstream rib 46 may be pressed against the upper surface of the pressing projection 29 by the weight of the separation guide 42 (not shown).

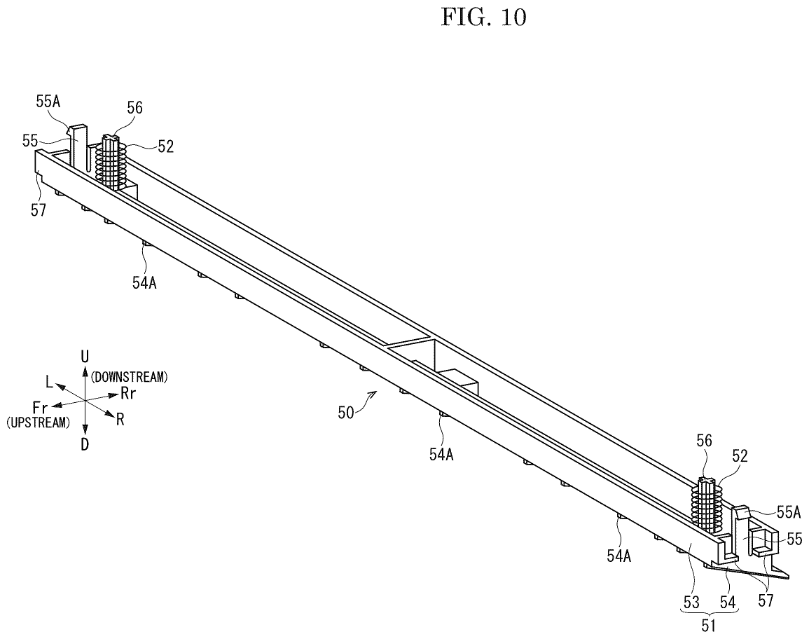

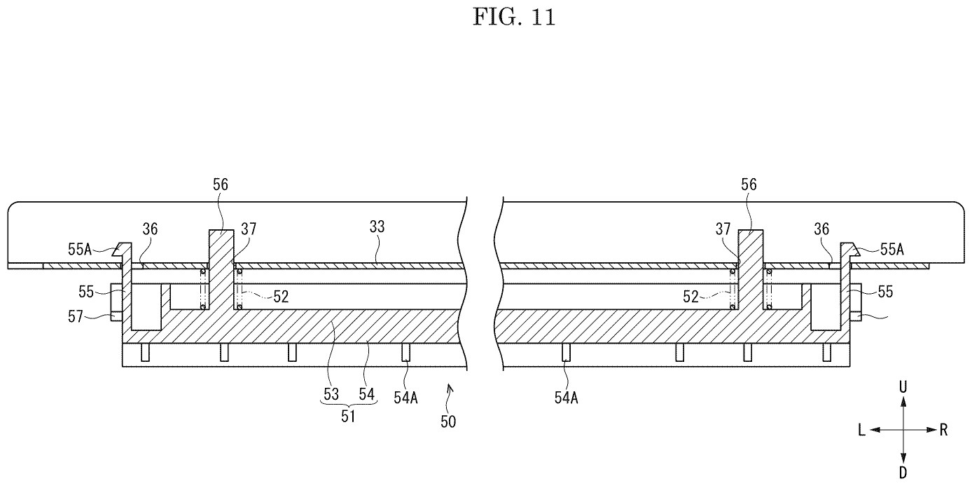

Meanwhile, the paper P passing through the pressurizing region N is separated from the surface of the fixing belt 20 by the separation guide 42, and conveyed while being guided by the conveying guide 51 disposed on the downstream side of the separation guide 42. During this conveying, since the paper P is conveyed while the surface on which the toner is fixed coming into contact with the conveying guide 51, when the contact pressure between the paper P and the conveying guide 51 is high, the fixed image on the paper P may rub against the conveying guide 51, and streaks (defective image) along the conveying direction may be formed on the fixed image. Furthermore, the toner on the paper P may adhere to the surface (lower surface) of the conveying guide 51. Therefore, the fixing device 7 according to this embodiment includes a structure (medium guide part 50) to suppress the above-mentioned problems caused by conveying the paper P while being into contact with the conveying guide 51.

[Details of the Medium Guide Part] With reference to FIG. 8, FIG. 10 and FIG. 11, details of the medium guide part 50 will be described. FIG. 10 is a perspective view showing the medium guide part 50. FIG. 11 is a cross-sectional view showing the medium guide part 50.

As shown in FIG. 8 and FIG. 10, the medium guide part 50 includes a conveying guide 51 and pair of conveying biasing members 52.

<Conveying Guide> The conveying guide 51 has a conveying body part 53 formed into a substantially box-shaped structure elongated in the left-and-right direction, and a guide surface part 54 formed into a substantially plate-shaped structure elongated in the left-and-right direction.

(Conveying Body Part) The conveying body part 53 is formed into a substantially box-shape slightly shorter in the left-and-right direction than the medium separation part 41. The conveying body part 53 is disposed on the downstream side of the medium separation part 41, between the pair of pressure-receiving plates 44C (see FIG. 8). A pair of anti-slip hooks 55, capable of deformation in the left-and-right direction by elastic force, are provided on the left and right side surfaces of the conveying body part 53. The pair of anti-slip hooks 55 extend upward from the left and right side surfaces of the conveying body part 53. An engagement claw 55A projects outward in the left-and-right direction from the tip (upper end) of each anti-slip hook 55.

Furthermore, on both front and rear sides across each anti-slip hook 55, a pair of turning restriction parts 57 project outward from the side surface of the conveying body part 53. Each turning restriction part 57 has a portion extending in the upper-and-lower direction and another portion extending from the lower end of the former portion toward the anti-slip hook 55, and is formed into a substantially L-shape when viewed from the side.

As shown in FIG. 11, the engagement claw 55A of each anti-slip hook 55 is inserted into an engagement hole 36 formed in the crossing frame 33 and engage with the edge of the engagement hole 36. The conveying body part 53 is suspended from the crossing frame 33 via the pair of anti-slip hooks 55. Furthermore, each anti-slip hook 55 is inserted into the engagement hole 36 in a state movable in the upper-and-lower direction. Therefore, the conveying guide 51 is movable along the moving direction of the fixing belt 20 (the upper-and-lower direction). The conveying guide 51 is disposed at the lowermost position in the state where each engagement claw 55A is engaged with the edge of the engagement hole 36. When the conveying guide 51 moves upward, each engagement claw 55A moves upward away from the edge of the engagement hole 36. Furthermore, the conveying guide 51 is disposed at the uppermost position in the state where the upper end of the conveying body part 53 is in contact with the lower surface of the crossing frame 33.

As shown in FIG. 10 and FIG. 11, a pair of spring shaft portions 56 are provided on the left and right portions of the conveying body part 53. The pair of spring shaft portions 56 are disposed closer to the center (inner side) in the left-and-right direction than the pair of anti-slip hooks 55, and extend upward from the bottom surface of the conveying body part 53. The upper portion of each spring shaft portion 56 is inserted into a guide hole 37 formed in the crossing frame 33. Each spring shaft portion 56 is inserted into the guide hole 37 in a movable state in the upper-and-lower direction.

When the pressure adjustment part 40 positions the fixing belt 20 (belt holding members 23) at the pressure increased position P1 and the separation guide 42 is in a substantially horizontal posture, the pair of downstream ribs 48 formed on the pressure-receiving plate 44C come into contact with the lower surface of the turning restriction part 57, and the conveying guide 51 is kept in its normal position (initial position P3) (see FIG. 4 and FIG. 5).

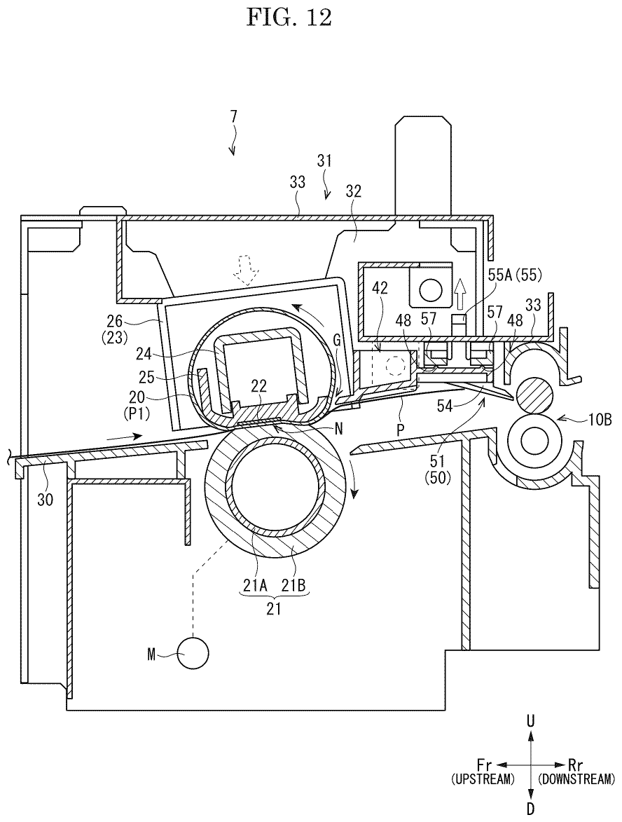

(Guide Surface Part) As shown in FIG. 10 and FIG. 11, the lower portion (lower surface) of the conveying body part 53 forms the guide surface part 54. Specifically, the guide surface part 54 is formed by the lower surface of the conveying body part 53 and a portion extending rearward (downstream) from the lower surface. The guide surface part 54 is formed to be in an inclined posture downward (in the pressure increasing direction) from the front (upstream side) toward the rear (downstream side). A plurality of conveying ribs 54A are formed on the guide surface part 54 via intervals in the left-and-right direction. Each conveying rib 54A extends in the conveying direction (front-and-rear direction) and projects downward from the guide surface part 54 (lower surface). The conveying guide 51 moves parallel in the upper-and-lower direction to maintain the inclined posture of the guide surface part 54.

<Conveying Biasing Member> As shown in FIG. 10 and FIG. 11, each conveying biasing member 52 is, for example, a compression coil spring wound around the spring shaft portion 56 of the conveying body part 53. Each conveying biasing member 52 is provided between the bottom surface of the conveying body part 53 (or the upper surface of the guide surface part 54) and the crossing frame 33, and biases the conveying guide 51 downward.

[Operation of the Medium Guide Part] With reference to FIG. 4, FIG. 5, and FIG. 12, the operation of the medium guide part 50 will be described. FIG. 12 is a cross-sectional view explaining the operation of the medium guide part 50. In the state where the pressure adjustment part 40 positions (push down) the fixing belt 20 (the belt holding members 23) at the pressure increased position P1, the conveying guide 51 is biased by each conveying biasing member 52 and positioned at the initial position P3 (see FIG. 4 and FIG. 5).

For example, when the image forming process (fixing process) is performed normally, the paper P passed through the pressurizing region N is conveyed downstream while being separated from the fixing belt 20 by the separation guide 42, and comes into contact with the conveying guide 51 (guide surface part 54). When the leading edge of the paper P is into contact with the guide surface part 54, as shown in FIG. 12, the conveying guide 51 is pressed by the conveyed paper P. For example, when the paper P is thin, such as a plain paper, the conveying guide 51 guides the paper P at the initial position P3 due to the biasing force of each conveying biasing member 52.

On the other hand, when the paper P is thick, such as a thick paper, the contact pressure applied on the guide surface part 54 by the paper P on the guide surface part 54 increases, thereby increasing the conveying load of the paper P. If the contact pressure becomes excessive, the conveying load may exceed the conveying force, causing conveying failure or jam. Therefore, in the case of thick paper P such as a thick paper, the conveying guide 51 moves upward from the initial position P3 against the biasing force of each conveying biasing member 52. More specifically, the vertical component of the contact pressure (force) applied by the paper P on the guide surface part 54 in the inclined posture moves the conveying guide 51 upward while compressing each conveying biasing member 52. By moving (retracting) the conveying guide 51 upward, the contact pressure applied on the guide surface part 54 by the paper P is absorbed (reduced).

The paper P is conveyed downstream while in contact with the guide surface part 54 (the conveying ribs 54A). When the trailing edge of the paper P passes over the guide surface part 54, the conveying guide 51 is biased by the conveying biasing members 52 and moves downward (returns to the initial position P3, see FIG. 4 and FIG. 5). In the description of the embodiment, the “upward” is one example of “the pressure decreasing direction along the moving direction of the fixing belt 20 from the pressure increased position P1 toward the pressure decreased position P2” as stated in the claims. Furthermore, the “downward” is one example of “the return direction opposite to the pressure decreasing direction” as stated in the claims.

In the fixing device 7 according to the embodiment described above, the conveying guide 51 is moved upward (in the pressure decreasing direction) to reduce the contact pressure which is applied from the conveyed paper P when the conveying guide 51 is pressed by the conveyed paper P. According to the configuration, the strong pressing of the image fixed on the paper P (fixed image) against the conveying guide 51 is suppressed, so that the occurrence of defective images, such as streaks along the conveying direction on the fixed image, can be suppressed. It also suppresses the adhesion of the toner on the paper P to the conveying guide 51 (guide surface part 54). That is, it suppresses problems caused by the paper P being conveyed while in contact with the conveying guide 51.

Furthermore, according to the fixing device 7 of the embodiment, the conveying biasing members 52 bias the conveying guide 51 to return, so that the paper P can be guided along the conveying guide 51 (guide surface part 54) while weakening the contact pressure applied to the conveying guide 51 from the paper P. This enables the paper P to be guided properly.

In the fixing device 7 of the embodiment, the conveying guide 51 is movable in the upper-and-lower direction, but the present disclosure is not limited to this. The conveying guide 51 needs only be movable to reduce (absorb) the contact pressure applied from the conveyed paper P when the conveying guide 51 is pressed by the paper P. For example, it may be movable in the left-and-right direction or movable in a diagonal direction (neither shown). In this case, the conveying biasing member 52 may apply the biasing force to the conveying guide 51 along the direction of movement of the conveying guide 51.

In the fixing device 7 of the embodiment, the conveying guide 51 is biased downward by the conveying biasing members 52, but the present disclosure is not limited to this. For example, the conveying biasing member 52 may be omitted, and the conveying guide 51 lifted by being pressed by the paper P may be lowered by its own weight (not shown).

Furthermore, in the fixing device 7 of the embodiment, the pressure adjustment part 40 are provided at both the end potions in the axial direction (left-and-right direction) of the fixing belt 20. However, the present disclosure is not limited thereto. For example, a single pressure adjustment part 40 may be provided on one side in the axial direction of the fixing belt 20, or it may be provided near the center in the axial direction (not shown).

In the fixing device 7 of the embodiment, the pressure roller 21 is driven by the driving force to rotate, and the fixing belt 20 rotates following the rotation of the pressure roller 21. However, the present disclosure is not limited to this configuration. Conversely, the fixing belt 20 may be driven by a driving force to rotate, and the pressure roller 21 may rotate following the rotation of the fixing belt 20.

Furthermore, the description of the above embodiment showed an example of applying the present disclosure to the monochrome image forming apparatus 1. However, the present disclosure is not limited to this, and may also be applied to, for example, a color printer, a copying machine, a facsimile machine, or multifunctional peripheral.

It should be noted that the description of the above embodiments shows one aspect of the fixing device and the image forming apparatus according to the present disclosure, and the technical scope of the present disclosure is not limited to the above embodiments. The disclosure may be variously modified, substituted, or modified without departing from the spirit of the technical idea, and the claims include all embodiments that may fall within the scope of the technical idea.

### Appendix 1

A fixing device according to Appendix 1 includes:
a fixing belt which has flexibility, is formed in a cylindrical shape extending in an axial direction, and heats toner on a medium while rotating around an axis;
a pair of belt holding members which are inserted into both ends of the fixing belt in the axial direction and hold the fixing belt in the cylindrical shape;
a pressure member which forms a pressurizing region between the fixing belt and the pressure member, and pressurizes the toner on the medium passing through the pressurizing region while rotating around an axis;
a pressure adjusting part which is connected to the fixing belt via the pair of the belt holding members, and moves the fixing belt between a pressure increased position at which the pressurizing region is increased in pressure and a pressure decreased position at which the pressurizing region is decreased in pressure;
a medium separation part including a separation guide which separates the medium after the medium passes through the pressurizing region, from the fixing belt; and
a medium guide part including a conveying guide which guides the medium separated from the fixing belt by the separation guide and conveyed, wherein
the separation guide is pressed against the pair of belt holding members and moves integrally with the fixing belt, and
the conveying guide moves in a pressure decreasing direction in which a contact pressure applied from the medium when the conveying guide is pressed by the conveyed medium is decreased.

### Appendix 2

The fixing device according to Appendix 2 is the fixing device according to Appendix 1, wherein,
the medium separation part includes:
the separation guide which is provided so as to be turnable around a separation turning shaft, and comes into contact with the pair of belt holding members from an upstream side of the separation turning shaft in a conveying direction of the medium and from the side of the pressurizing region, and
a separation biasing member which presses the separation guide against the pair of belt holding members, wherein
the medium guide part includes:
the conveying guide which is provided movably along a moving direction of the fixing belt, pressed by the conveyed medium, and moves in the pressure decreasing direction along the moving direction from the pressure increased position to the pressure decreased position, and
a conveying biasing member which biases the conveying guide in a return direction opposite to the pressure decreasing direction.

### Appendix 3

The fixing device according to Appendix 3 is the fixing device according to Appendix 1 or 2, wherein
the conveying guide has a guide surface part inclined downward to a downstream side of the conveying direction, and moves while maintaining an inclined posture of the guide surface part.

### Appendix 4

The fixing device according to Appendix 4 is the fixing device according to any one of Appendixes 1 to 3, wherein
the separation guide has a pair of pressure-receiving plates, and
the conveying guide is disposed between the pressure-receiving plates.

### Appendix 5

An image forming apparatus according to Appendix 5 includes the fixing device according to any one of Appendixes 1 to 4.

What is claimed is:

1. A fixing device comprising:
a fixing belt which has flexibility, is formed in a cylindrical shape extending in an axial direction, and heats toner on a medium while rotating around an axis;
a pair of belt holding members which are inserted into both ends of the fixing belt in the axial direction and hold the fixing belt in the cylindrical shape;
a pressure member which forms a pressurizing region between the fixing belt and the pressure member, and pressurizes the toner on the medium passing through the pressurizing region while rotating around an axis;
a pressure adjusting part which is connected to the fixing belt via the pair of the belt holding members, and moves the fixing belt between a pressure increased position at which the pressurizing region is increased in pressure and a pressure decreased position at which the pressurizing region is decreased in pressure;
a medium separation part including a separation guide which separates the medium after the medium passes through the pressurizing region, from the fixing belt; and
a medium guide part including a conveying guide which guides the medium separated from the fixing belt by the separation guide and conveyed, wherein
the separation guide is pressed against the pair of belt holding members and moves integrally with the fixing belt, and
the conveying guide moves in a pressure decreasing direction in which a contact pressure applied from the medium when the conveying guide is pressed by the conveyed medium is decreased.

2. The fixing device according to claim 1, wherein,
the medium separation part includes:
the separation guide which is provided so as to be turnable around a separation turning shaft, and comes into contact with the pair of belt holding members from an upstream side of the separation turning shaft in a conveying direction of the medium and from the side of the pressurizing region, and
a separation biasing member which presses the separation guide against the pair of belt holding members, wherein
the medium guide part includes:
the conveying guide which is provided movably along a moving direction of the fixing belt, pressed by the conveyed medium, and moves in the pressure decreasing direction along the moving direction from the pressure increased position to the pressure decreased position, and
a conveying biasing member which biases the conveying guide in a return direction opposite to the pressure decreasing direction.

3. The fixing device according to claim 1, wherein
the conveying guide has a guide surface part inclined downward to a downstream side of the conveying direction, and moves while maintaining an inclined posture of the guide surface part.

4. The fixing device according to claim 1, wherein
the separation guide has a pair of pressure-receiving plates, and
the conveying guide is disposed between the pressure-receiving plates.

5. An image forming apparatus comprising:
the fixing device according to claim 1.
